(19) United States
(12) Patent Application Publication
(10) Pub. No.: US 2019/0272509 A1
(43) Pub. Date: Sep. 5, 2019

(54) Space Reservation Real-Time Optimization Management System Based on Participants' Location and Behavioral Parameters and Method of Operating Thereof

(71) Applicant: Effective Technology Solutions, Inc., Mountain View, CA (US)

(72) Inventors: Noam Livnat, Mountain View, CA (US); Shahar Alster, Mountain View, CA (US); Ram Akuka, Mountain View, CA (US)

(73) Assignee: Effective Technology Solutions, Inc.

(21) Appl. No.: 16/290,657

(22) Filed: Mar. 1, 2019

Related U.S. Application Data
(60) Provisional application No. 62/636,854, filed on Mar. 1, 2018.

(51) Int. Cl. G06Q 10/10; H04W 4/02

(52) U.S. Cl. CPC G06Q 10/1095; H04W 4/023

(57) ABSTRACT

A novel space reservation real-time optimization management system incorporates potential meeting participants' real-time location and behavioral parameters gathered from participants' electronic devices, employee databases, and/or in-room occupancy sensors to generate a machine-determined optimal office space and resource assignment to the potential meeting participants. Preferably, the machine determined office space assignment is not finalized until a scheduled meeting time nears a just-in-time (JIT) threshold value for the machine-based real-time space optimization. By deferring the finalized machine-determined decision on office space and resource assignments until the JIT threshold value is reached, this novel system is able to perform and analyze machine-tracked real-time location and behavioral characteristics of potential meeting participants as well as the real-time availability of a pool of office spaces and other office resources until the last possible moment for a robust, relevant, and accurate machine determination of optimal office space and resource assignments to the potential meeting participants.

### BACKGROUND OF THE INVENTION

The present invention generally relates to space optimization systems and methods. More specifically, the present invention relates to a real-time machine determination of optimal space reservation and assignments based on participants' location and behavioral characteristics and real-time occupancy sensing among registered spaces.

Office space configuration practices have undergone significant changes over the last few decades. Newly-emphasized business operational concepts, such as easing communication barriers and increasing collaboration among coworkers, and maximizing space efficiency under ever-increasing commercial real estate rental costs have provided an impetus for a transition from private or shared office environments to open-plan seating. Such changes in workplace seating arrangements over the last few decades have introduced new challenges for professional space management and operation.

In particular, the increased emphasis on worker collaboration, coupled with less emphasis on more private meeting spaces that were offered in one's own office, created insatiable demand for meeting rooms. Meeting rooms in professional office spaces have become a scarce resource that may benefit from reservation optimizations. A traditional “first come-first serve” concept has become increasingly ineffective in making such meeting rooms readily available to a plurality of meeting demands, thus causing unnecessary frustration and reducing work productivity.

Conventional methods of reserving professional spaces for meeting purposes include utilizing Microsoft's Exchange, Office 365, or similar products to manage a calendar for a shared-use resource (e.g. a meeting room). When a meeting organizer or a meeting participant (i.e. a user) wants to reserve a shared-user resource in a conventional resource reservation system, the user typically creates an event object using a calendar-scheduling application (e.g. Microsoft Outlook, Google Calendar, etc.) and “invites” the resource he would like to reserve. The conventional system would then display the resource's calendar availability and would automatically accept the user's invitation to the event if the resource's calendar is free at the desired time.

Furthermore, some conventional resource reservation systems incorporate resource search and filter functionalities to allow a user to identify available and desired resources. For example, the user may search for and find a meeting room that can accommodate a minimum of six people and has remote videoconferencing capabilities. However, a statically-finalized reservation of a desired meeting room or another sharable resource from the user's own manual selection may often result in wasteful and/or non-optimal allocations of scarce resources in a professional office space environment, which in turn may worsen worker productivity and contentions for reserving the scarce resources.

For instance, a user may have reserved a six-person meeting room when five people were initially invited to a meeting. If only two people accept invitations to attend the meeting, the meeting would still take place in the six-person room when a conventional resource reservation system is utilized. A three-person room may have been sufficient to fulfill the needs of the meeting, but the statically-finalized reservation at the outset of the meeting scheduling allocates the six-person meeting room despite the smaller-than-expected actual size of the attendees for this meeting, thus leaving larger groups that may have wanted the six-person meeting room with fewer resource choices.

In another example, a user may be unable to reserve a six-person room when creating a meeting invitation because all such rooms are already booked and thus resorts to reserving a smaller room, or simply postpones or cancels the meeting. Subsequently, if at least one six-person room that has been previously booked is canceled at the last minute, that particular six-person room may remain empty because the user is simply unware of the unexpected availability of the right-sized room for a desired occasion.

Yet in another example, a user may have a recurring one-on-one meeting scheduled in a six-person room because this was the only room available at the time when the first meeting was set up. Subsequently, smaller rooms have become available, but the original recurring scheduling in the six-person room is not dynamically or intelligently reallocated to a smaller room suitable for the one-on-one meeting, thus wasting resources by occupying an unnecessarily large room for the occasion. Furthermore, last-minute changes to meeting attendance (e.g. much fewer people showing up, meeting not taking place without removing it from a shared resource calendar, etc.) also result in sub-optimal resource utilization.

As a result of notable inefficiencies in shared resource management in conventional resource reservation systems, business entities often experience unintended loss of productivity arising from meeting delays, cancellations, and unoptimized impromptu allocation of limited shared resources, such as conference rooms and other shared professional office spaces and equipment.

Therefore, it may be desirable to provide a novel electronic system capable of real-time assignment and re-allocation of office space and equipment resources based on dynamically-changing conditions of each resource and potential participants' current and historical behaviors and locations relative to available resources. In addition, it may also be desirable to provide a mobile application and/or other application modules that provide electronic user interfaces to enable a meeting organizer or a participant to initiate, update, and/or receive machine-determined dynamic and optimized assignment of a shared resource in a professional office environment.

Furthermore, it may also be desirable to provide a method of operating a novel electronic system capable of real-time assignment and re-allocation of office space and equipment resources based on dynamically-changing conditions of each resource and potential participants' current and historical behaviors and locations relative to available resources.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a space reservation real-time optimization management system based on participants' location and behavioral parameters is disclosed. This system comprises: an occupancy sensor located in an office space to identify or detect presence of a potential meeting participant; a participant's real-time location and behavioral parameter module executed in a portable electronic device carried by the potential meeting participant, wherein the participant's real-time location and behavioral parameter module accumulates and then transmits real-time location trend characteristics and real-time behavioral trend characteristics of the potential meeting participant to a space reservation real-time optimization management module executed in a computer server; a space reservation application executed in the portable electronic device or another computerized device operated by the potential meeting participant to provide an electronic user interface that enables the potential meeting participant to request, accept, modify, or cancel a meeting with other potential meeting participants at a specified meeting timeslot; and the space reservation real-time optimization management module operatively connected to the occupancy sensor and the participant's real-time location and behavioral parameter module via a data network, wherein the space reservation real-time optimization management module provides a just-in-time (JIT) assignment of a machine-determined optimal office space for the meeting with other potential meeting participants based on occupancy sensor data, the real-time location trend characteristics, and the real-time behavioral trend characteristics of the potential meeting participant and the other potential meeting participants, when a JIT threshold value is reached prior to the specified meeting timeslot.

Furthermore, in another embodiment of the invention, a method for operating a space reservation real-time optimization management system based on participants' location and behavioral parameters is disclosed. This method comprises the steps of: scheduling a meeting by a potential meeting participant at a specified meeting timeslot via an electronic user interface generated by a space reservation application executed on a portable electronic device or on another computerized device operated by the potential meeting participant; generating a machine-determined initial “likelihood feedback” to the potential meeting participant that indicates a likely office space for a machine-determined space assignment under an initial set of the participants' location and behavioral parameters, wherein the machine-determined space assignment is finalized at a later time when a just-in-time (JIT) threshold value is reached prior to the specified meeting timeslot; tracking RSVPs, cancellations, real-time location parameters, and real-time behavioral parameters of a plurality of potential meeting participants, and updating real-time location trend characteristics and real-time behavioral trend characteristics of the plurality of potential meeting participants; when the JIT threshold value is reached prior to the specified meeting timeslot, executing the machine-determined space assignment to finalize reservation of a machine-determined optimal office space for the meeting, based on dynamically-changing real-time location trend characteristics and real-time behavioral trend characteristics of the plurality of potential meeting participants; and releasing remaining non-optimal office spaces from the machine-determined space assignment for ad-hoc space reservation requests.

### BRIEF DESCRIPTION OF DRAWINGS

FIG. 1 shows an embodiment of a space reservation real-time optimization management system based on participants' location and behavioral parameters, in accordance with an embodiment of the invention.

FIG. 2 shows a space reservation real-time optimization management module, in accordance with an embodiment of the invention.

FIG. 3 shows a participant's real-time location and behavioral parameter module, in accordance with an embodiment of the invention.

FIG. 4 shows a participant's portable electronic device for a space reservation real-time optimization management system based on participants' location and behavioral parameters, in accordance with an embodiment of the invention.

FIG. 5 shows an operational flowchart for a space reservation real-time optimization management system based on participants' location and behavioral parameters, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of descriptions of shapes, configurations, and/or other symbolic representations that directly or indirectly resemble one or more space reservation real-time optimization management systems based on participants' location and behavioral parameters, and methods of operating such systems. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention does not inherently indicate any particular order nor imply any limitations in the invention.

For the purpose of describing the invention, a term referred to herein as a “resource” is defined as a sharable business asset that may benefit from systemic scheduling and reservation for serialized or simultaneous utilizations of that particular sharable business asset by one or more groups of employees, contractors, other professionals, or students. Examples of “resources” include, but are not limited to, meeting rooms, conference halls, auditoriums, cubicles, private office spaces, desks, chairs, tables, display projectors, display panels, videoconferencing or teleconferencing devices, and recreational sports equipment.

In addition, for the purpose of describing the invention, a term referred to herein as “space” is defined as business, corporate, and/or academic premises that may be utilized by one or more group of people. For example, a “space” may be a conference room, a private office, a cubicle area, an auditorium, or a lunch room in a corporate building.

Moreover, for the purpose of describing the invention, a term referred to herein as a “module” is defined as a specialized logical component comprising one or more software and/or chip-encoded hardware logical units that perform special-purpose task(s) and function(s) to enable specialized functionalities in a space reservation real-time optimization management system.

Furthermore, for the purpose of describing the invention, a term referred to herein as a “behavioral parameter” is defined as a measurable dataset for a potential meeting participant's historical and/or current behavior, which may be recorded or extrapolated from a portable electronic device utilized by the potential meeting participant, sensors, and/or other datasets. Examples of behavioral parameters include, but are not limited to, frequency of staying in one part of an office space over another, tendency of utilizing one meeting room over another, meeting avoidance traits in certain time brackets in a typical workweek, and preferential characteristics of choosing one office equipment over another.

One aspect of an embodiment of the present invention is providing a space reservation real-time optimization management system capable of real-time assignment and re-allocation of office space and equipment resources based on dynamically-changing conditions of each resource and potential participants' current and historical behaviors and locations relative to available resources.

Furthermore, another aspect of an embodiment of the present invention is providing a mobile application and/or other application modules that generate electronic user interfaces to enable a meeting organizer or a participant to initiate, update, and/or receive machine-determined (i.e. artificial intelligence-determined) dynamic and optimized assignment of a shared resource in a professional office environment.

Yet another aspect of an embodiment of the present invention is providing a method of operating a space reservation real-time optimization management system, which is capable of real-time assignment and re-allocation of office space and equipment resources based on dynamically-changing conditions of each resource and potential participants' current and historical behaviors and locations relative to available resources.

In a preferred embodiment of the invention, the method of operating the space reservation real-time optimization management system may involve six-step processes. In the first step, when a user wants to schedule a meeting, the user indicates to the space reservation real-time optimization management system who the invitees are, the desired meeting date, time, duration, and other requirements (e.g. remote conferencing, whiteboard, etc.) from the meeting resources. The user may optionally provide additional requirements and/or indicate the priority of the different requirements, such as date/time flexibility and desired vs. required equipment. Importantly, the user is not required to specify a particular meeting room resource, even if certain room preferences are indicated.

In the second step, the space reservation real-time optimization management system receives the user's request and provides feedback of the likelihood of meeting the user's requirements/preferences. In contrast to conventional existing systems, the space reservation real-time optimization management system may not immediately reserve or assign a specific resource for the user, if the system operator or the meeting organizer prefers just-in-time (JIT) dynamic allocations of office space and equipment resources. Furthermore, the system can utilize rating algorithms to calculate the optimal resource allocation based on current requests for the future time, and offer the user an estimate of the likelihood of meeting his/her requirements. In addition, the system may offer alternatives, based on current and historical data, that have higher probability of meeting the user's requirements. For this purpose, the system may take the following criteria into account: 1) Demand and availability of resources in adjacent time slots or locations (e.g. you're more likely to have the room you want if you switch the meeting time to 11AM) 2) The calendar availability of attendees (e.g. most attendees are also available at 11AM, when there's less demand for meeting rooms). 3) The expected location of the user and attendees prior to the meeting time (e.g. Joe will be in building 5, so won't be able to make it by LOAM to a meeting in Building A) 4) Historical attendance information (e.g. many requested meetings are likely to be canceled, have reduced attendance, two of your attendees are not likely to attend, etc.).

In the third step, the space reservation real-time optimization management system tracks ongoing updates to meeting requests and RSVPs. For example, the user may update requirements, preferences, and priorities at any time, including attendees invited. Furthermore, attendees may update their RSVP response and other parameters at any time, and users may cancel meetings altogether.

In the fourth step, as the meeting time nears, the space reservation real-time optimization management system incorporates stored information and real-time data into optimizing the resource assignment. Real time locations of attendees may be utilized for various tasks. For example, attendees' real time locations may be utilized to: 1) Assess whether they can physically attend the meeting (e.g. if Eve is in Washington, D.C., she's not likely to be able to meet in Building A in Mountain View, Calif.). 2) Assess which meeting rooms are within reasonable ranges so that the attendees will be able to make the meeting in time (e.g. Eve is in Building A so it'd be more efficient for her to meet in Building A rather than Building B), while minimizing walking time. 3) Assess whether their current meetings are running over and the attendees may not join the meeting that's about to start. Furthermore, RSVP status of the attendees may be provided directly, or deduced from machine-determined autonomous analysis of email replies (e.g. “I'll be at the meeting”), text messages, and attendees' calendars (e.g. indicating where they may be present).

In addition, attendees' historical meeting patterns indicating the likelihood of their participation in the meeting, attendees' titles, organizational ranks, or resource priority measures may also be autonomously analyzed by the space reservation real-time optimization management system to determine meeting room assignment priorities. Moreover, the space reservation real-time optimization management system may also take account of real-time sensor information related to the current use of the resources and/or meeting rooms. For example, if a rooms is continuously occupied, the ongoing meeting may be running over, and the system may determine that it is better to direct a new meeting to a different room. Likewise, if people are leaving a room, the system may determine that the present meeting is winding down. The space reservation real-time optimization management system may also utilizes a rules engine, a hard-coded logic, and/or artificial intelligence (AI) models for autonomous machine-based detection and determination of real-time room availability and room and equipment resource assignment prioritizations.

In the fifth step, once a determination for resource assignment has been made attendees are notified. Preferably, the space reservation real-time optimization management system is configured to make decisions for multiple requests simultaneously or serially, depending on user or operator preferences. In the preferred embodiment of the invention, notification may be in any form of communication such as email, text message, instant message, push notification, etc. The content of each notification may include location, time, meeting duration, and any other relevant instructions associated with the scheduled meeting. Furthermore, some notifications may be in the form of “flight board” displays, public broadcast systems, etc.

In the sixth step, the space reservation real-time optimization management system tracks the actual “claiming” of resources through various methods to determine the current usage of the claimed resources and the number of people involved utilizing such claimed resources. If the resources (e.g. meeting rooms, room equipment, etc.) are not currently utilized, they may be released back to the pool of available resources, and potential attendees' behavioral data are collected and analyzed for future resource allocation optimizations.

In one embodiment of the invention, users may attempt to claim a meeting room directly or delegate the meeting room assignment to the space reservation real-time optimization management system. Real-time location sensing of people potentially associated with a meeting schedule can also determine the state of individual attendance in the meeting room. The real-time location sensing methods may involve Bluetooth, Wireless LAN, GPS, and face recognition systems to determine the current location or the presence of a particular individual associated with the meeting schedule. A user can also actively claim the meeting room through a locally-available electronic interface such as an iPad, a button, a QR code scan, and a voice command interface.

Furthermore, presence sensing may be achieved by infrared, sonic, visual, and/or other environmental sensors to track and determine who and how many people have entered, stayed, and/or existed the meeting room. In addition, the space reservation real-time optimization management system is configured to track who actually attended the meeting compared with RSVP responses. The system can also track other meeting characteristics, such as the duration of a meeting and office equipment actually utilized vs. not utilized after an initial request. These additional meeting characteristics accumulated by the space reservation real-time optimization management system can then be used to train artificial intelligence models to predict expected behaviors of individuals, groups, and other office space-related optimization applications. Moreover, in some embodiments of the invention, the additional meeting characteristics accumulated by the space reservation real-time optimization management system can also be used to update and fine-tune optimization rule parameters utilized in the resource allocation process.

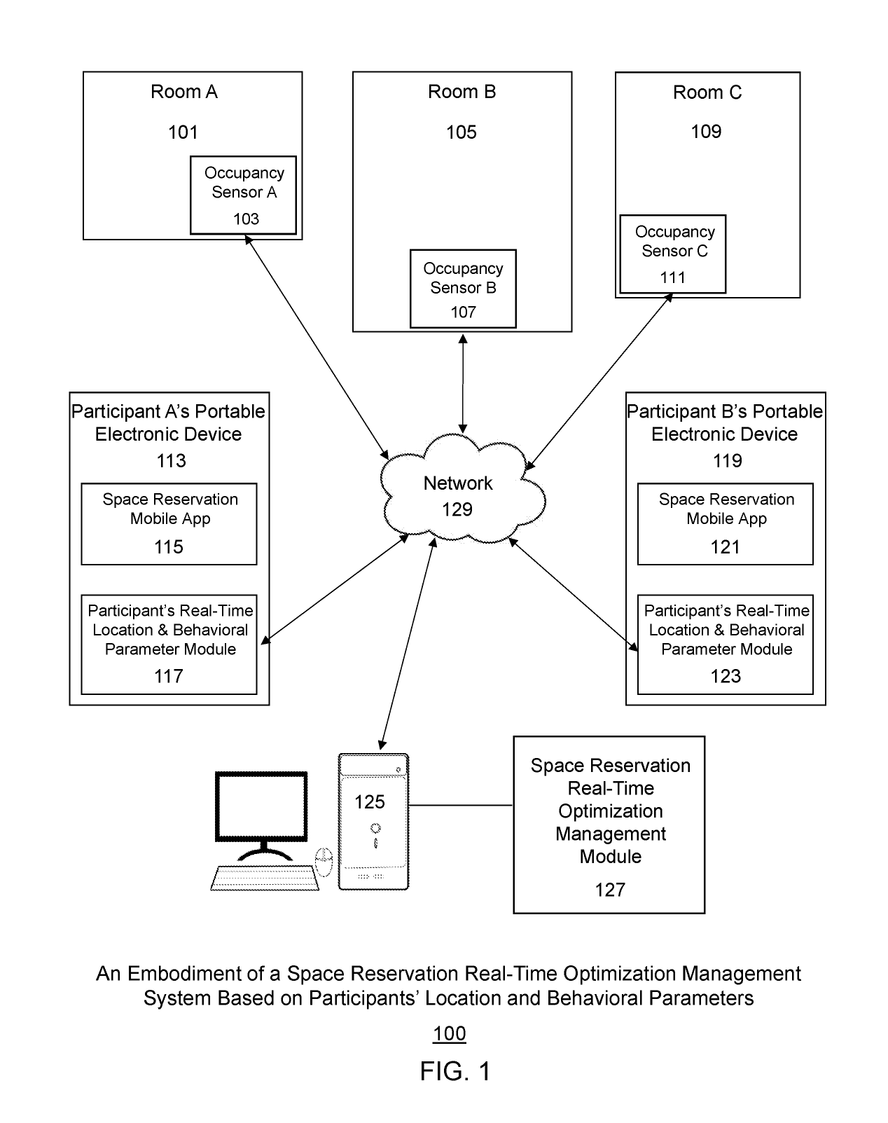

FIG. 1 shows an embodiment of a space reservation real-time optimization management system (100) based on participants' location and behavioral parameters, in accordance with an embodiment of the invention. In a preferred embodiment of the invention, the space reservation real-time optimization management system (100) comprises one or more office spaces, such as “Room A” (101), “Room B” (105), “Room C” (109), which integrate occupancy sensors (103, 107, 111). Occupancy sensors may be infrared motion sensors, closed-circuit TVs, ultrasonic and/or laser sensors, facial recognition systems, QR code scanners, or another suitable sensory unit that can detect real-time presence or absence of humans inside each corresponding office space that installed an occupancy sensor. In some embodiments of the invention, occupancy sensors integrate facial recognition systems to detect and identify individual faces of meeting participants by comparing the detected faces to a facial and/or visual database of employees and/or potential meeting participants.

As shown in FIG. 1, the occupancy sensors are operatively connected to one or more portable electronic devices (113, 119) utilized by potential meeting participants and to a computer server (125) that executes a space reservation real-time optimization management module (127) via a data network (129). The space reservation real-time optimization management module (127) is configured to intelligently and autonomously determine, assign, or re-assign an optimal office space based on real-time changes of potential participants' needs, location, behaviors, and external factors (e.g. new meeting room availability due to sudden cancellations of a scheduled meeting by another group, etc.).

Moreover, in one embodiment of the invention, a first participant's portable electronic device (113) incorporates a space reservation mobile app (115) and a first participant's real-time location and behavioral parameter module (117). Similarly, a second participant's portable electronic device (119) incorporates a space reservation mobile app (121) and a second participant's real-time location and behavioral parameter module (123). The space reservation mobile apps (115, 121) are configured to generate an electronic user interface to enable each potential meeting participant to request, update, and receive a machine-determined real-time allocation or re-allocation of an office space reservation.

Furthermore, in a preferred embodiment of the invention, the real-time location and behavioral parameter modules (117, 123) are configured to detect, track, analyze, and transmit a variety of participant location and behavioral parameters to the space reservation real-time optimization management module (127) that controls machine-determination of dynamic allocation and adjustments of various office space reservations and shared resource scheduling. The space reservation real-time optimization management module (127) is capable of determining an optimal office space assignment on a just-in-time (JIT) basis when a scheduled meeting timeslot nears a threshold value for the JIT allocation or re-allocation of office spaces. The JIT assignment of the machine-determined optimal office space may place optimization priorities on participants' minimized movement requirements, minimized travel costs, increased participant productivity, urgency or importance of the meeting relative to other meetings, or median ranks of the plurality of potential meeting participants as organizational efficiency measures in machine-determined office space selection and assignment criteria.

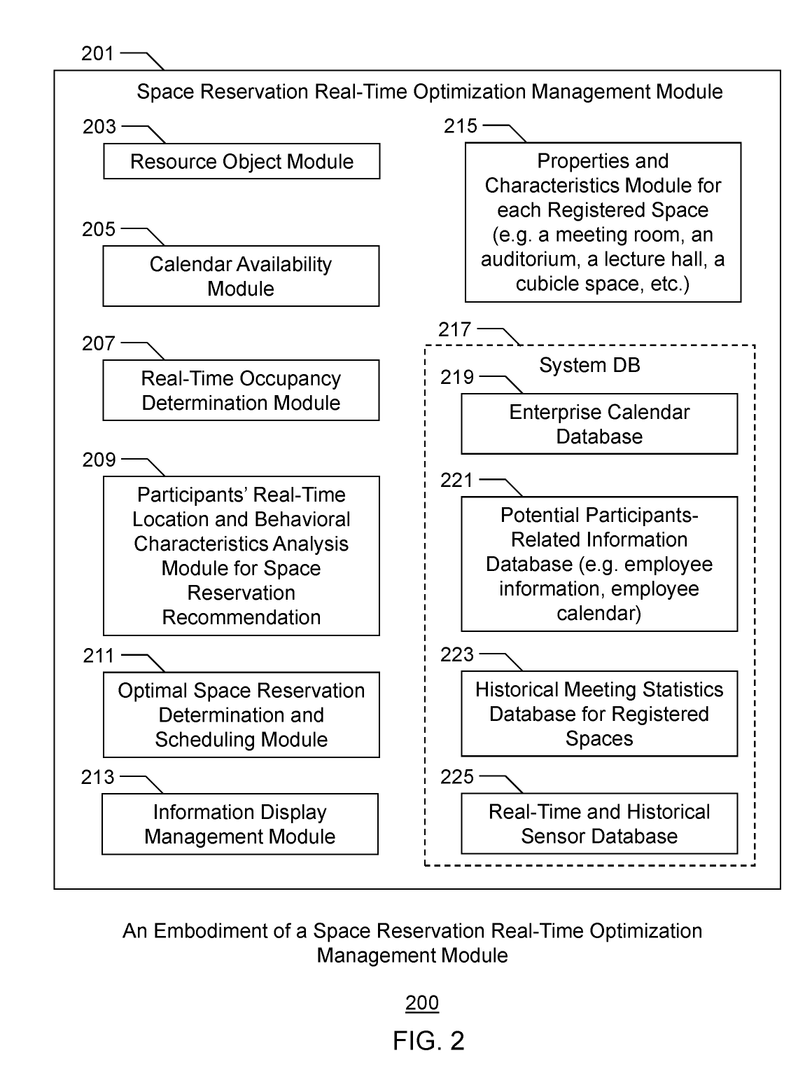

FIG. 2 shows a preferred embodiment (200) of a space reservation real-time optimization management module (201). The space reservation real-time optimization management module (201) in this embodiment comprises a resource object module (203), a calendar availability module (205), a real-time occupancy determination module (207), a participants' real-time location and behavioral characteristics analysis module for space reservation recommendation (209), an optimal space reservation determination and scheduling module (211), an information display management module (213), a properties and characteristics module for each registered space (215), and a system database (217).

In the preferred embodiment of the invention as illustrated in FIG. 2, the resource object module (203) stores a plurality of resource objects, wherein each resource object defines and characterizes a specific resource (e.g. an office room, an office equipment, etc.) that can be utilized in a space reservation real-time optimization management system. For example, a resource object defining “Room A” (101 in FIG. 1) may contain dimensions and occupancy capacity of the room, as well as any office equipment or in-room sensors associated with the resource object. In some instances, the resource object may also contain a past usage history of the resource object and/or a current state of its utilization (e.g. room occupied for a meeting, vacant, under construction, etc.). If the resource object is an office equipment, such as a display projector, a desktop computer, a podium, a computer desk, a conference table, etc., then the resource object may contain device characteristics information outlining its capabilities, dimensions, usage history, and/or current state of utilizations in association with another resource object (e.g. an occupied meeting room, an occupied auditorium, etc.).

Continuing with the embodiment of the invention as shown in FIG. 2, the calendar availability module (205) is configured to track and update availability of each resource object by a calendar-based timeslot. For example, the calendar availability module (205) may track and update meeting room availability information for “Room A” (101), “Room B” (105), “Room C” (109) as well as availability of office equipment, furniture, and devices. Furthermore, the participants' real-time location and behavioral characteristics analysis module for space reservation recommendation (209) is configured to receive and accumulate potential meeting participants' real-time location and behavioral characteristics information from occupancy sensors, environmental sensors, online calendar records, employee records, email or text message communications, location tracking from potential meeting participants' portable electronic devices, and/or other sensory or contextual information sources.

Preferably, at least some of the participants' real-time location and behavioral characteristics are originating from the participants' real-time location and behavioral parameter modules (i.e. 117, 123, 301), which are executed on participants' portable electronic devices. The participants' real-time location and behavioral characteristics analysis module for space reservation recommendation (209) is able to continuously monitor and analyze any changes to participants' real-time locations and behavioral characteristics, in an effort to elicit material information (e.g. commonly-visited location trends, average physical distances between a potential space for reservation and real-time locations of potential participants, frequency of meetings among potential participants, employee grade levels, etc.) that may improve efficiency of space reservations and related work productivity.

Then, when a just-in-time (JIT) threshold for a dynamically-determined space reservation is reached to reserve or assign a particular space, the participants' real-time location and behavioral characteristics analysis module for space reservation recommendation (209) is configured to generate a prioritized list of available spaces as a space reservation recommendation. In the preferred embodiment of the invention, an available space flagged as a higher selectable priority, as opposed to a lower selectable priority, indicates a machine-determined preference of an office space assignment that can achieve higher efficiency and optimization levels, compared to the lower selectable priority also determined by the system. Based on the recommendations from the participants' real-time location and behavioral characteristics analysis module (209) and any pertinent real-time information from the real-time occupancy determination module (207) and the properties and characteristics module for each registered space (215), the optimal space reservation determination and scheduling module (211) is able to perform a machine-determined optimal space reservation assignment for a particular meeting group. Furthermore, in some instances, the optimal space reservation determination and scheduling module (211) is capable of executing the machine-determined optimal space reservation assignments simultaneously for a multiple number of meeting groups and office resources.

In the embodiment of the invention as shown in FIG. 2, the real-time occupancy determination module (207) is operatively connected to one or more occupancy sensors (e.g. 103, 107, 111), and is able to detect, analyze, and determine whether a particular office space is previously or currently occupied by one or more individuals. In some instances, if the particular office space is occupied, the real-time occupancy determination module (207), in conjunction with the participants' real-time location and behavioral characteristics analysis module (209), may also be able to identify specific individuals who are occupying the particular office space and contribute to the optimization of the machine-determined office space assignment accordingly. For example, if two individuals that are flagged for an upcoming meeting in “Room B” (105 in FIG. 1) are already occupying “Room B,” then the real-time occupancy determination module (207) may detect those specific individuals in real time, and inform the participants' real-time location and behavioral characteristics analysis module (209) and/or the optimal space reservation determination and scheduling module (211) to place the machine-determined upcoming meeting room assignment priority to “Room B,” in order to minimize participants' movement distances and to maximize worker/participant productivity.

Furthermore, in the preferred implementation of the space reservation real-time optimization management module (201) as shown in FIG. 2, the properties and characteristics module for each registered space (215) may store detailed real-time characteristics of a registered space, such as a meeting room, an auditorium, a lecture hall, and a cubicle space. In some embodiments, the properties and characteristics module for each registered space (215) stores dynamically-changing and detailed information that are updated in real-time via occupancy and/or environmental sensors for a plurality of registered spaces, while the resource object module (203) stores more basic and static information related to fundamental characteristics of each resource object, which may include either registered or unregistered space with the space reservation rea-time optimization management module (201). In other embodiments, the resource object module (203) and the properties and characteristics module for each registered space (215) may be combined into one module for keeping track of a plurality of resource objects, including both unregistered and registered office spaces.

In the preferred embodiment of the invention, the optimal space reservation determination and scheduling module (211) is able to provide a just-in-time (JIT) allocation or re-allocation of a particular sharable resource (e.g. a meeting room, a conference hall, a lecture hall, an office equipment, etc.) when a meeting time approaches a JIT threshold value (e.g. 30 minutes prior to the scheduled meeting time), based on dynamically-changing parameters gathered and analyzed from real-time occupancy information, resource object status information, calendar availability information, participants' location and behavioral characteristics analysis, and historical information associated with potential participants and resource objects that may have been accumulated over time via the system database (217) and/or sensors and cameras located in the premises. In the preferred embodiment of the invention, what is considered by the machine to be an “optimal” office space assignment may be based on a system operator preference for minimizing average travel distances among meeting participants, prioritizing specific in-room office equipment requested by a meeting organizer, prioritizing meetings of higher importance defined by participants' ranks or reasons for such meetings, matching an expected size of a meeting to right-sized dimensions of an available room to maintain a robust efficiency for right-sizing space allocations among a limited pool of available space resources, and/or other work productivity and operational efficiency improvement criteria specified by the system operator.

Furthermore, as shown in FIG. 2, the system database (217) may incorporate an enterprise calendar database (219), a potential participants-related information database (221), a historical meeting statistics database for registered spaces (223), and a real-time and historical sensor database (225). In the preferred embodiment of the invention, the space reservation real-time optimization management module (201) is executed as a collection of software, as chip-level hard-coded hardware blocks, or as a combination thereof in a computer server and/or another computing device. As previously shown in FIG. 1, the space reservation real-time optimization management module (127) executed by the computer server (125) may utilize the logic structure of the space reservation real-time optimization management module (201) as described in FIG. 2. Alternatively, in another embodiment of the invention, the space reservation real-time optimization management module (127) of FIG. 1 may utilize another logical block design to serve identical or similar functionalities of the preferred embodiment (i.e. as disclosed in FIG. 2) of the space reservation real-time optimization management module design.

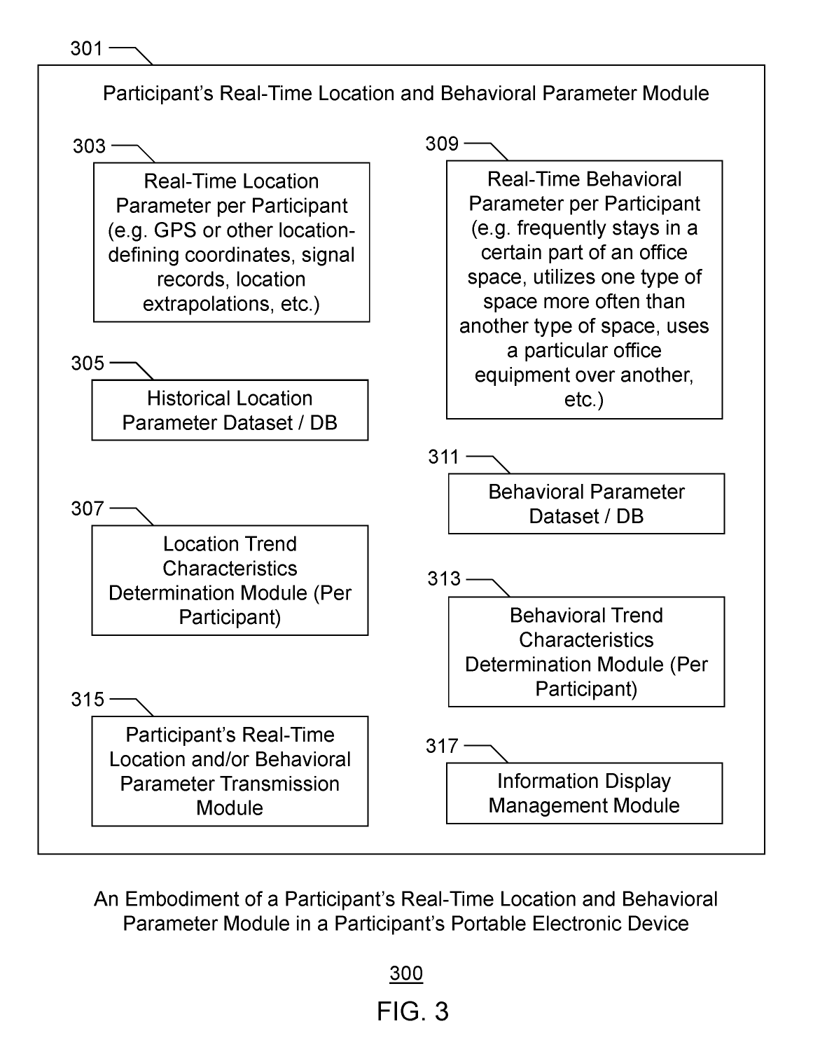

FIG. 3 shows a preferred embodiment (300) of a participant's real-time location and behavioral parameter module (301), in accordance with an embodiment of the invention. As shown previously in FIG. 1, a real-time location and behavioral parameter module (e.g. 117 or 123 in FIG. 1) is typically integrated in a portable electronic device utilized by a potential meeting participant. The participant's real-time location and behavioral parameter module (301) illustrated in FIG. 3 discloses the preferred embodiment (300) of this module logic block design that incorporates a variety of software and/or chip hard-coded hardware units. The preferred embodiment (300) of the participant's real-time location and behavioral parameter module (301) includes a real-time location parameter per participant (e.g. GPS or other location defining coordinates, signal records, location extrapolations, etc.) (303), a historical location parameter dataset or database (305), a location trend characteristics determination module per participant (307), a real-time behavioral parameter per participant (309), a behavioral parameter dataset or database (311), and a behavioral trend characteristics determination module per participant (313), as shown in FIG. 3. The participant's real-time location and behavioral parameter module (301) may further include a participant's real-time location and/or behavioral parameter transmission module (315) and an information display management module (317).

In a preferred embodiment of the invention, the real-time location parameter per participant (303) includes one or more real-time location-defining coordinates that are detectable by an occupancy sensor, a GPS tracking device, or another location tracking device. The real-time location parameter per participant (303) may also include previous location signal records, location information deduced indirectly from one or more electronic devices associated with a potential or actual meeting participant, and any participant-specific information related to real-time location tracking. An accumulated set of such real-time location parameters for a plurality of meeting participants may be continuously or periodically stored in the historical location parameter dataset database (305), which can be accessed dynamically by other logical units in the participant's real-time location and behavioral parameter module (301). Furthermore, potential or actual meeting participants' location trend characteristics (e.g. staying most frequently on a particular floor or in a particular conference room this week, six out of ten potential meeting participants staying outside the company's office space in the last two days for an external marketing presentation, etc.) may be tracked, analyzed, and machine-determined in real time by the location trend characteristics determination module (307), the output of which is transmitted to the space reservation real-time optimization management module (201) by the participant's real-time location and/or behavioral parameter transmission module (315).

Preferably, the space reservation real-time optimization management module (201) receives potential or actual meeting participants' location trend characteristics from a multiple number of portable electronic devices, each of which executed a unique instance of real-time location and behavioral parameter module specific to one potential or actual meeting participant. The space reservation real-time optimization management module (201) is able to further utilize location trend characteristics information originating from the location trend characteristics determination module (307) in the participant's real-time location and behavioral characteristics analysis module for space reservation recommendation (209) and the optimal space reservation determination and scheduling module (211) to conduct a machine determination of an optimal space reservation or assignment for a particular meeting group.

Furthermore, the real-time behavioral parameter per participant (309) in the participant's real-time location and behavioral parameter module (309) includes variables that define each participant's behavioral characteristics. Examples of participants' behavioral parameters include, but are not limited to, tendency to prefer certain types of office spaces over other types for meeting reservations, certain office equipment over other equipment, and certain types of meals and snacks over other types. An accumulated set of the participants' behavioral parameters may be continuously or periodically stored in the behavioral parameter dataset database (311), which can be accessed dynamically by other logical units in the participant's real-time location and behavioral parameter module (301). Furthermore, potential or actual meeting participants behavioral characteristics may be tracked, analyzed, and machine-determined in real time by the behavioral trend characteristics determination module (313), the output of which is transmitted to the space reservation real-time optimization management module (201) by the participant's real-time location and/or behavioral parameter transmission module (315).

Preferably, the space reservation real-time optimization management module (201) receives potential or actual meeting participants' behavioral trend characteristics from a multiple number of portable electronic devices, each of which executed a unique instance of real-time location and behavioral parameter module specific to one potential or actual meeting participant. The space reservation real-time optimization management module (201) is able to further utilize behavioral trend characteristics information originating from the behavioral trend characteristics determination module (313) in the participant's real-time location and behavioral characteristics analysis module for space reservation recommendation (209) and the optimal space reservation determination and scheduling module (211) to conduct a machine determination of an optimal space reservation or assignment for a particular meeting group.

Moreover, the participant's real-time location and behavioral parameter module (301) may also incorporate a privacy control feature that may prohibit, disable, or enable an employer or a manager access to an employee's potentially-sensitive data involving real-time and historical location and behavioral parameters. In certain instances, the employer or the manager may be empowered to override the employee's privacy control and access location and behavioral parameters anyway, especially in situations where the employer or the manager believes that a company policy violation or an illegitimate action has been incurred by the employee in question.

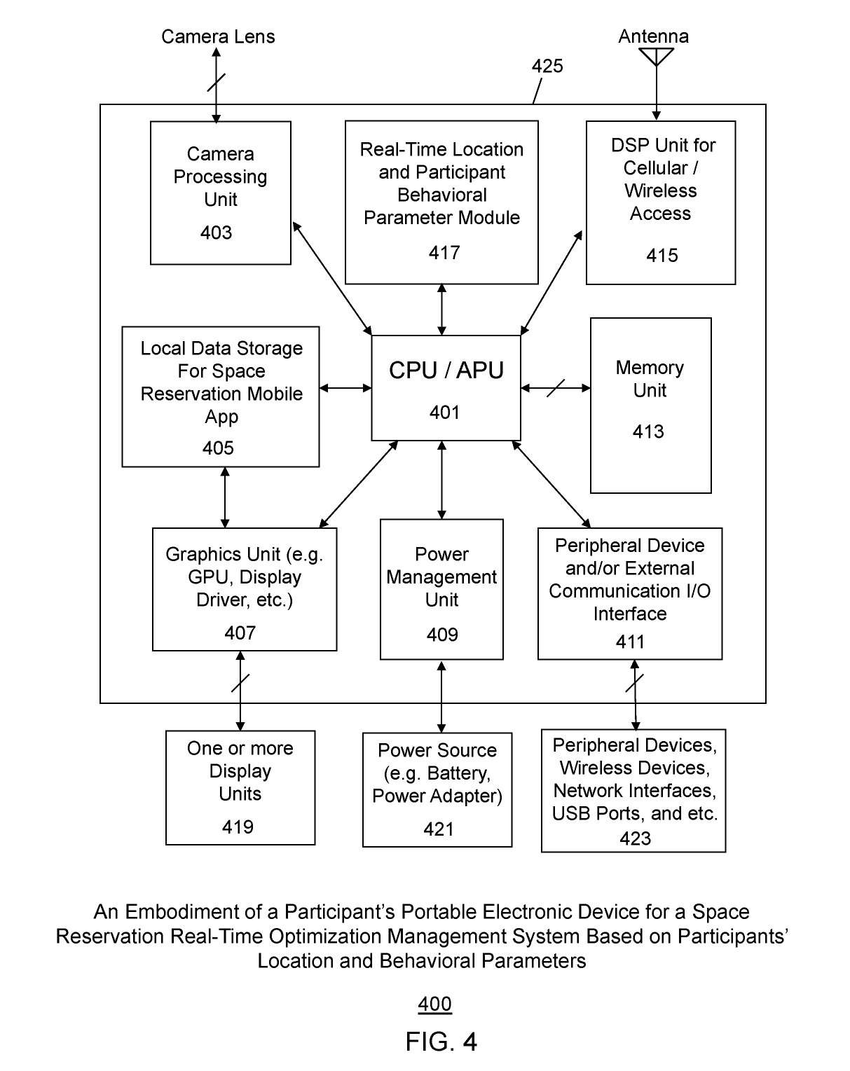

FIG. 4 shows an embodiment (400) of a participant's portable electronic device (425) for a space reservation real-time optimization management system based on participants' location and behavioral parameters, in accordance with an embodiment of the invention. The participant's portable electronic device (425) may be a smart phone, a tablet computer, a notebook computer, a wearable device, or another electronic device that can be readily carried around by a potential meeting participant in a professional environment. As illustrated in FIG. 4, the participant's portable electronic device (425) for the space reservation real-time optimization management system incorporates a real-time location and participant behavioral parameter module (417) and a local data storage that stores a space reservation mobile app that can be loaded onto a CPU/APU (401) and a memory unit (413).

In a preferred embodiment of the invention, the real-time location and participant behavioral parameter module (417) may be implemented with various sub-modules (e.g. 303, 305, 307, 309, 311, 313, 315, 317) that are illustrated and described in association with FIG. 3. Furthermore, the real-time location and participant behavioral parameter module (417) may comprise one or more software elements stored in a non-volatile data storage, or embedded software elements hard-coded and incorporated in a semiconductor chip as a piece of hardware. Preferably, the portable electronic device executes a space reservation mobile application (e.g. 115, 121 in FIG. 1) as well as the real-time location and participant behavioral parameter module (417 in FIGS. 4, 117 and 123 in FIG. 1) for a particular participant. In some embodiments of the invention, at least a portion of the functionality of the real-time location and participant behavioral parameter module (417) is also provided by a computer server or a cloud-based computing resource, which is operatively connected to the participant's potable electronic device (425).

As shown in FIG. 4, the portable electronic device (425) incorporates a CPU or an APU (401), which is operatively connected to a memory unit (413), a local data storage (405) that stores the space reservation mobile application, a camera processing unit (403), a graphics unit (407) (e.g. a graphics processor, a display driver, and etc.), a power management unit (409), a peripheral device and/or external communication I/O interface (411), a digital signal processing (DSP) unit for cloud server access (415), the real-time location and participant behavioral parameter module (417), and a sound unit. These logical units may be placed on a single printed circuit board in one embodiment of the invention, or a plurality of printed circuit boards in another embodiment of the invention.

In the preferred embodiment of the invention, the CPU/APU (401) is configured to control each logical unit operatively (i.e. directly or indirectly) connected to the CPU/APU (401). The memory unit (413) typically comprises volatile memory banks based on DRAM's. In some embodiments of the invention, the memory unit (413) may use non-volatile memory technologies such as SRAM's and/or Flash memory. The memory unit (413) is capable of storing programs and applications which can be executed by the CPU/APU (401), the graphics unit (407), or another logical unit operatively connected to the memory unit (413).

In particular, in the preferred embodiment of the invention, instructions, datasets, and codes originating from the real-time location and participant behavioral parameter module (417) can be executed on the CPU/APU (401) and the memory unit (413) of the portable electronic device to provide one or more electronic user interfaces associated with the space reservation mobile application and the space reservation real-time optimization management system operations. The real-time location and participant behavioral parameter module (417) may be a separate standalone logical unit, as shown previously in FIG. 3, or a collection of software or machine codes associated with the space reservation mobile application and/or the space reservation real-time optimization management system operations in the local data storage (405).

Continuing with FIG. 4, any software and programs executed on the CPU/APU (401) and the memory unit (413) of the portable electronic device (425) may be part of an operating system, or a separate application installed on the operating system of the portable electronic device. Furthermore, the camera processing unit (403) is operatively connected to a camera lens on the portable electronic device, and is able to process image-related data from the camera lens in association with the CPU/APU (401) and/or other logical units in the portable electronic device to produce live recorded video information, which may be stored in the local data storage (405) containing the space reservation mobile application. In addition, a microphone operatively connected to the sound unit can produce live recorded audio information, which can also be stored in the local data storage (405) containing the space reservation mobile application.

Moreover, as shown in FIG. 4, the digital signal processing (DSP) unit for cloud server access (415) is operatively connected to an radio frequency (RF) antenna. The DSP unit for cloud server access (415) is generally configured to receive and transmit radio data and/or voice signals wirelessly for a desktop computer, a laptop, a mobile communication device, an electronic goggle, or another suitable electronic system. In addition, the power management unit (409) is operatively connected to a power supply unit and a power source (e.g. battery, power adapter) (421), and the power management unit (409) generally controls power supplied to the portable electronic device and its logical units. Moreover, the peripheral device and/or external communication I/O interface (411) as shown in FIG. 4 can be operatively connected to one or more peripheral devices, wireless devices, USB ports, and other external data communication media (423).

Continuing with FIG. 4, in the preferred embodiment of the invention, the graphics unit (407) in the system block diagram example for the portable electronic device comprises a graphics processor, a display driver, a dedicated graphics memory unit, and/or another graphics-related logical components. In general, the graphics unit (407) is able to process and communicate graphics-related data with the CPU/APU (401), the display driver, and/or the dedicated graphics memory unit. The graphics unit (407) is also operatively connected to one or more display units (419). In addition, the CPU/APU (401) may be operatively connected to the sound unit which contains audio-related logical components for generation or recording of audio data from a microphone operatively connected to the portable electronic device.

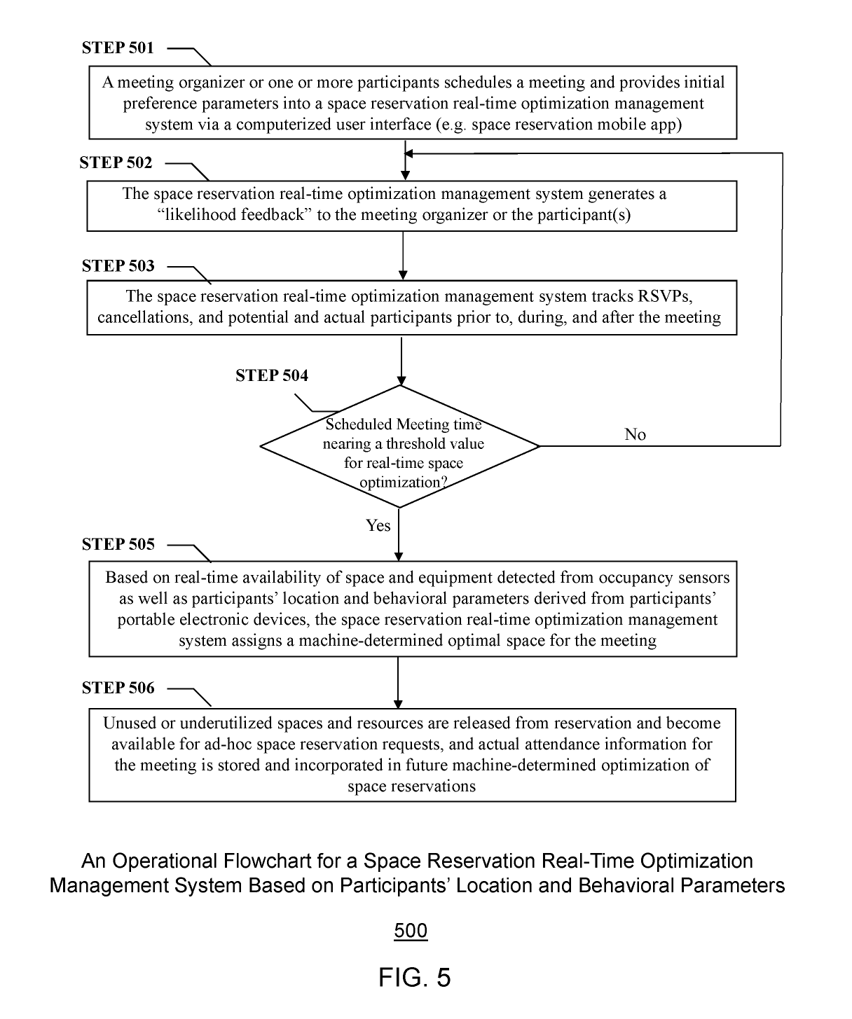

FIG. 5 shows an operational flowchart (500) for a space reservation real-time optimization management system based on participants' location and behavioral parameters, in accordance with an embodiment of the invention. The space reservation real-time optimization management system first generates an electronic user interface that enables a meeting organizer or potential participants to configure a preferred meeting time, location, and initial preference parameters, such as preferred office space dimensions, in-room equipment, and floor levels, as shown in STEP 501. The electronic user interface may be generated by a space reservation mobile app executed on a participant's portable electronic device, which further enables the participant to update or receive information associated with dynamic space reservation assignments and re-allocations based on real-time changes on various parameters. The participant's portable electronic device can also function as a primary tracking device for the participant's location and behavioral preferences and changes that can be incorporated into an AI/machine determination of optimized real-time re-allocation of office space assignments.

Once the participant has configured various initial preference parameters for a potential space reservation via the electronic user interface, the space reservation real-time optimization management system is able to generate a “likelihood feedback” to the participant or to a meeting organizer, as shown in STEP 502. In a preferred embodiment of the invention, this “likelihood feedback” is the machine's best initial guess for an office space and/or a resource assignment, which gets finalized only after a scheduled meeting time approaches or exceeds a just-in-time (JIT) threshold value. In general, the likelihood feedback by the system is only an initially-estimated assignment of an office space (e.g. a conference room) and/or other office resources (e.g. a particular brand and model among a plurality of display projectors, a particular brand and model among a plurality of large-screen televisions, particular snacks and meals preferred by the majority of scheduled meeting attendees, etc.). Subsequently, the space reservation real-time optimization management system tracks RSVPs, meeting cancellations, and potential and actual participants before, during, and after various meetings that take place in a professional office environment, as shown in STEP 503. When the scheduled meeting time initially configured by the participant or the meeting organizer approaches a just-in-time (JIT) threshold value (e.g. 20 minutes before the scheduled meeting time, etc.) as shown in STEP 504, the space reservation real-time optimization management system dynamically assigns a machine-determined optimal space for the meeting, based on real-time availability of space and equipment detected from occupancy sensors and various participants' location and behavioral parameters that are derived from participants' portable electronic devices, as shown in STEP 505.

After the dynamic allocation or re-allocation process is completed as a finalized decision by artificial intelligence, any unused or underutilized spaces and office equipment resources that were previously on hold prior to the finalized decision are released from reservation and become available for ad-hoc space reservation requests by registered office workers, as shown in STEP 506. Furthermore, actual attendance information for the meeting is stored and incorporated in future AI/machine-determined optimization of space reservations, as also shown in STEP 506.

One advantage of an embodiment of the present invention, compared to existing conventional meeting reservation tools, is the space reservation real-time optimization management system's unique and novel capability to provide real-time assignments and re-allocations of office space and equipment resources based on dynamically-changing conditions of each resource and potential participants' current and historical behaviors and locations relative to available resources.

Furthermore, another advantage of an embodiment of the present invention, compared to existing conventional meeting reservation tools, is the novel space reservation real-time optimization management system's integral utilization of a mobile application and/or other application modules that generate electronic user interfaces to enable a meeting organizer or a participant to initiate, update, and/or receive machine-determined (i.e. artificial intelligence-determined) dynamic and optimized assignment of a shared resource in a professional office environment.

Moreover, another advantage of an embodiment of the present invention, compared to existing conventional meeting reservation tools, is the method of operating the novel space reservation real-time optimization management system for just-in-time (JIT) efficiencies achieved by real-time assignment and re-allocation of office space and equipment resources based on multivariable simultaneous considerations of dynamically-changing conditions of each resource and potential participants' current and historical behaviors and locations relative to available resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims presented herein.

What is claimed is:

1. A space reservation real-time optimization management system based on participants' location and behavioral parameters, the system comprising:
an occupancy sensor located in an office space to identify or detect presence of a potential meeting participant;
a participant's real-time location and behavioral parameter module executed in a portable electronic device carried by the potential meeting participant, wherein the participant's real-time location and behavioral parameter module accumulates and then transmits real-time location trend characteristics and real-time behavioral trend characteristics of the potential meeting participant to a space reservation real-time optimization management module executed in a computer server;
a space reservation application executed in the portable electronic device or another computerized device operated by the potential meeting participant to provide an electronic user interface that enables the potential meeting participant to request, accept, modify, or cancel a meeting with other potential meeting participants at a specified meeting timeslot; and
the space reservation real-time optimization management module operatively connected to the occupancy sensor and the participant's real-time location and behavioral parameter module via a data network, wherein the space reservation real-time optimization management module provides a just-in-time (JIT) assignment of a machine-determined optimal office space for the meeting with other potential meeting participants based on occupancy sensor data, the real-time location trend characteristics, and the real-time behavioral trend characteristics of the potential meeting participant and the other potential meeting participants, when a JIT threshold value is reached prior to the specified meeting timeslot.

2. The space reservation real-time optimization management system of claim 1, further comprising one or more office equipment dynamically allocated into the machine-determined optimal office space based on the real-time location trend characteristics and the real-time behavioral trend characteristics of the potential meeting participant and the other potential meeting participants.

3. The space reservation real-time optimization management system of claim 1, wherein the space reservation real-time optimization management module comprises a resource object module, a calendar availability module, a real-time occupancy determination module, a participants' real-time location and behavioral analysis module for space reservation recommendation, an optimal space reservation determination and scheduling module, an information display management module, and a properties and characteristics module for each registered space.

4. The space reservation real-time optimization management system of claim 3, wherein the space reservation real-time optimization management module further comprises a system database executed in the computer server, which includes an enterprise calendar database, a potential participants-related information database, a historical meeting statistics database for registered spaces, and a real-time and historical sensor database.

5. The space reservation real-time optimization management system of claim 1, wherein the participant's real-time location and behavioral parameter module executed in the portable electronic device includes a real-time location parameter per participant, a historical location parameter dataset database, a location trend characteristics determination module per participant, a real-time behavioral parameter per participant, a behavioral parameter dataset database, a behavioral trend characteristics determination module, a participant's real-time location and behavioral parameter transmission module, and an information display management module.

6. The space reservation real-time optimization management system of claim 1, wherein the just-in-time (JIT) assignment of the machine-determined optimal office space places optimization priorities on participants' minimized movement requirements, minimized travel costs, increased participant productivity, urgency or importance of the meeting relative to other meetings, or median ranks of the plurality of potential meeting participants as organizational efficiency measures in machine-determined office space selection and assignment criteria.

7. Minimized participants' movement requirements, increased participants' productivity, or minimized travel costs as organizational efficiency measures in machine-determined office space selection and assignment criteria.

8. The space reservation real-time optimization management system of claim 1, wherein the occupancy sensor is an infrared motion sensor, a machine or computer-vision sensor, a closed-circuit TV, an ultrasonic or laser sensor, a facial recognition system, a QR code scanner, or a combination thereof

9. The space reservation real-time optimization management system of claim 1, wherein the portable electronic device is a smart phone, a tablet computer, a notebook computer, a wearable device, or another electronic device carried around by the potential meeting participant.

10. The space reservation real-time optimization management system of claim 1, wherein the data network is a cellular communication network, a wireless LAN, a satellite communication network, a wired cable communication network, or a combination thereof

11. A method for operating a space reservation real-time optimization management system based on participants' location and behavioral parameters, the method comprising the steps of:
scheduling a meeting by a potential meeting participant at a specified meeting timeslot via an electronic user interface generated by a space reservation application executed on a portable electronic device or on another computerized device operated by the potential meeting participant;
generating a machine-determined initial “likelihood feedback” to the potential meeting participant that indicates a likely office space for a machine-determined space assignment under an initial set of the participants' location and behavioral parameters, wherein the machine-determined space assignment is finalized at a later time when a just-in-time (JIT) threshold value is reached prior to the specified meeting timeslot;
tracking RSVPs, cancellations, real-time location parameters, and real-time behavioral parameters of a plurality of potential meeting participants, and updating real-time location trend characteristics and real-time behavioral trend characteristics of the plurality of potential meeting participants;
when the JIT threshold value is reached prior to the specified meeting timeslot, executing the machine-determined space assignment to finalize reservation of a machine-determined optimal office space for the meeting, based on dynamically-changing real-time location trend characteristics and real-time behavioral trend characteristics of the plurality of potential meeting participants; and
releasing remaining non-optimal office spaces from the machine-determined space assignment for ad-hoc space reservation requests.

12. The method of claim 10, further comprising a step of tracking actual attendance information from the meeting for future machine-determined optimization of space reservations.

13. The method of claim 10, wherein the machine-determined space assignment to finalize reservation of the machine-determined optimal office space for the meeting places optimization priorities on participants' minimized movement requirements, minimized travel costs, increased participant productivity, urgency or importance of the meeting relative to other meetings, or median ranks of the plurality of potential meeting participants as organizational efficiency measures in machine-determined office space selection and assignment criteria.
